(19) United States
(12) Patent Application Publication
(10) Pub. No.: US 2011/0283673 A1
(43) Pub. Date: Nov. 24, 2011

(54) Agricultural working machine comprising a front attachment

(76) Inventors: Claus Moersch, Langenberg (DE); Mcihael Baranski, Altenbeken OT. Schwaney (DE); Michael Kuehn, Beelen (DE)

(21) Appl. No.: 13/103,654

(22) Filed: May 9, 2011

(30) Foreign Application Priority Data
May 21, 2010 (DE) 10 2010 021 133.8

(51) Int. Cl. A01D 75/18

(52) U.S. Cl. 56/14.9

(57) ABSTRACT

An agricultural working machine has a vehicle, a front attachment guided such that it is swivelable about an axis in a direction of travel during a harvesting operation, a frame on which working tools are mounted, and an element provided on a chassis of the vehicle and/or the front attachment for applying a force that counteracts a swivel motion of the vehicle or the front attachment induced by a parameter selected from the group consisting of driving speeds, uneven terrain and both.

### CROSS-REFERENCE TO A RELATED APPLICATION

The invention described and claimed hereinbelow is also described in German Patent Application DE 10 2010 021 133.8 filed on May 21, 2010. These German Patent Applications , whose subject matter is incorporated here by reference, provides the basis for a claim of priority of invention under 35 U.S.C. 119(a)-(d).

### BACKGROUND OF THE INVENTION

The present invention relates to an agricultural working machine comprising a carrier vehicle and a front attachment mounted thereon, e.g. a combine harvester or a forage harvester, comprising a header. In efforts to increase the productivity of harvesting work, headers having increasingly greater working widths have been developed in recent years. Widths exceeding 10 meters are no longer unusual. Such a header is generally mounted in the center on a feed drive of the carrier vehicle. if roiling motions of the header are induced during operation, high, destructive torques can occur on the suspension. The ends of the header can reach high speeds, and so, if they strike the ground, there is also the risk that the header will become damaged.

Document EP 1 611 781 B1 makes known a self-propelled harvesting machine, in the case of which the height of a front attachment is continually adjusted during operation to maintain a desired working height above the ground. in that particular case, the front attachment is supported by two wheels which can be retracted and extended using lifting cylinders, to adjust the working height of the front attachment. The lifting cylinders are double-acting and comprise chambers on the face-end and on the piston-ring side. The face-end side chambers of the two lifting cylinders are interconnected, and the piston-ring side chambers can be interconnected using control valves. Sensing straps disposed in front of the wheels detect the distance of the front attachment to the ground and thereby deliver information required to actuate the control valves. If a sensing strap detects a low area in the ground, the lifting cylinder of the wheel following same is extended and, simultaneously, the lifting cylinder of the opposite wheel is retracted in that hydraulic fluid from a pump is applied to the piston-ring side chamber of said latter lifting cylinder, flows out of the face-end side chamber of this lifting cylinder and into the face-end side chamber of the first lifting cylinder, and out of the piston-ring side chamber thereof to the tank.

If the harvesting machine makes a turning maneuver, it is often necessary to lift the front attachment to avoid striking an obstacle. In this raised position, neither the sensing straps nor the wheels have contact with the ground. Rolling motions of the vehicle are transferred to the front attachment. The ends thereof can reach considerable speed due to their large distance from the roll axis. If, in the course of such a rolling motion, one of the wheels strikes the ground, the hydraulic fluid in the face-end side chambers of the lifting cylinders becomes highly pressurized. Since it cannot flow out and is incompressible, the lifting cylinders lock up. The resulting abrupt deceleration can cause damage to the front attachment.

### SUMMARY OF THE INVENTION

The problem addressed by the present invention is that of improving the operating safety of such an agricultural working machine.

The problem is solved in the case of an agricultural working machine comprising a vehicle and a front attachment which is guided such that it can swivel about an axis in the direction of travel during the harvesting operation, and comprises a frame on which working tools are mounted, by providing means on the chassis of the vehicle or the front attachment for applying a force that counteracts a swivel motion of the vehicle or the front attachment induced by driving speeds and/or uneven terrain.

Preferably these means act on the front attachment, since the mass thereof is less and thus the force or power required to suppress the swivel motion is less than if the aim were to suppress the swivelling of the vehicle.

The means for applying a force to the front attachment, which counteracts a swivel motion of the front attachment, comprises at least two interspaced supports which are disposed on the frame in a vertically movable manner for supporting, in contact with the ground, at least a portion of the weight of the front attachment, and which can yield reversibly in order to apply a supporting force to counteract the swivel motion of the front attachment when at least one of the supports contacts the ground. Instead of yielding without force, or locking up upon contact with the ground, the supports therefore induce a gradual deceleration of the rolling motion of the front attachment, which prevents the frame from coming in contact with the ground, or at least dampens same to the extent that damage is prevented.

The yielding of the supports should be reversible, to allow the supports to apply their damping effect if contact is made with the ground a second time. However, the speed of the reversing motion of the supports should be adapted to the elasticity of a connection between the vehicle and the front attachment, i.e. it should be so low that, after the front attachment undergoes a deflection relative to the vehicle, which caused a support to yield, the return motion of the front attachment driven by the elasticity of the connection causes the support to lose contact with the ground during the return motion.

The maximum load-carrying capacity of the supports is preferably less than the weight of the front attachment, thereby ensuring that this weight is also carried in part by the elastic connection to the vehicle.

In a first preferred embodiment, the supports comprise at least a first lifting cylinder, and the pressure in at least one chamber of the first lifting cylinder is limited by a pressure relief valve. Therefore, when the pressure in said chamber exceeds the limiting pressure of the pressure relief valve due to ground contact by the support, hydraulic fluid can flow out of the chamber, wherein energy is withdrawn from the motion of the front attachment in proportion to the limiting pressure and the outflowing quantity of hydraulic fluid.

In a second preferred embodiment, the supports comprise at least one first lifting cylinder having a chamber connected to a first buffer, and, if the maximum load-carrying capacity is exceeded, hydraulic fluid can be displaced out of the at least one chamber and into the first buffer.

In both embodiments, a coupling device can be provided between the supports so that, if one of the supports yields under load, the other support can be moved in the same direction as the first support. Such a design makes it possible to sum the load-carrying capacities of the individual supports; i.e., if only one of the two supports has ground contact, the load-carrying capacity thereof is as great as that of both supports when they both have ground contact.

A coupling of this type can be embodied in particular in that the first and a second lifting cylinder are double-acting, and each comprises a first chamber which can be acted upon with hydraulic fluid to exert a downwardly directed force onto the support assigned to the particular lifting cylinder, and a second chamber which can be acted upon with hydraulic fluid to apply an upwardly directed force onto the support, and the coupling between the cylinders is established by the first chamber of the second lifting cylinder communicating with the second chamber of the first lifting cylinder.

Since the pressure in the first chambers of the lifting cylinders supports the weight of the front attachment, the first chambers are preferably face-end side chambers, since they generally have a larger cross section than do piston-ring side chambers. The larger the cross section, the lower the pressure required in the first chambers to generate the setpoint supporting force.

In the case of the first embodiment, it is sufficient for only the first chamber of the first lifting cylinder to communicate wtih the above-mentioned pressure relief valve, since the first chamber of the second lifting cylinder, when it yields, can release hydraulic fluid to the second chamber of the first lifting cylinder.

To ensure that the motions of the first support and the second support are the same even though the cross sections of the face-end side chamber and the piston-ring side chamber of one lifting cylinder differ, the first lifting cylinder preferably has a larger cross section than does the second lifting cylinder, according to the first embodiment.

A releasable non-return valve is preferably provided between the second chamber of the second cylinder and a tank. Such a non-return valve permits a support to yield at any time if the maximum load-carrying capacity thereof is exceeded, and in the blocked state can prevent the support from moving in the reverse direction.

The second embodiment is preferably symmetrical in terms of the connections between the lifting cylinders, i.e. the second chamber of the second lifting cylinder communicates with the first buffer, and the first chamber of the second lifting cylinder and the second chamber of the first lifting cylinder communicate with a second buffer.

In the state of equilibrium, according to this embodiment, the pressures in the first and second chambers of the two lifting cylinders are the same, and a supporting force results from the fact that the two chambers have a smaller cross section than do the first chambers.

A tip of the support that touches the ground can be designed as a skid or a roller.

Means for detecting the vertical position can be provided on at least one of the supports, to implement automatic regulation of the working height of the front attachment on the basis of the vertical position detected as a result, as described in EP 1 611 781 B1, for example.

To absorb the fluctuating load of the front attachment, the vehicle can also be advantageously equipped with a crawler track assembly.

Further features and advantages of the invention will become apparent from the description of embodiments that follows, with reference to the attached figures. In the drawings:

### BRIEF DESCRIPTION OF THE DRAWINGS

FIG. 1 shows a schematic depiction of an agricultural working machine according to the present invention;

FIG. 2 shows a schematic depiction of a hydraulic system which supports the front attachment, according to a first embodiment;

FIG. 3 shows a second embodiment of the hydraulic system;

FIG. 4 shows the hydraulic system according to a third embodiment; and

FIG. 5 shows a fourth embodiment of the hydraulic system.

### DESCRIPTION OF THE PREFERRED EMBODIMENTS

FIG. 1 shows a schematic view of an agricultural working machine according to the invention, comprising a vehicle 1 and a front attachment 2 mounted on a front side of vehicle 1. The working machine can be, in particular, any type of self-propelled harvesting machine, in particular a combine harvester or a forage harvester, and front attachment 2 is a header adapted for the particular crop to be harvested. A frame of the header comprises, in a manner know per se, a floor plate 3 having movable knives on front edge 4 thereof, side panels 5, and a rear panel 7. A feed roller 6 is rotatably mounted between side panels 5. A feed rake 8 of the vehicle engages at rear panel 7. Feed rake 8 is resiliently supported on vehicle 1 and forms a four-joint connection between front attachment 2 and vehicle 1, which permits rolling motions (i,e. swivel motions about an axis oriented in the direction of travel) of front attachment 2 relative to vehicle 1, and upward and downward motions while retaining the orientation of front attachment 2 in three dimensions.

A lifting cylinder 9 and 10 (hidden in FIG. 1) is mounted on each of the side panels 5, on connecting rod 23 of which—which is directed toward the ground—a skid 11 is installed. The two lifting cylinders 9, 10 are provided to support a portion of the weight of front attachment 2; the rest of the weight bears via feed rake 8 on the ground drive of vehicle 1.

In the usual case, said ground drive can comprise two or more axles having pneumatic wheels 12; in the present case, a crawler track assembly 13 provided at least on a front axle of vehicle 1 is preferable in order to compensate for the load of front attachment 2, which fluctuates during operation.

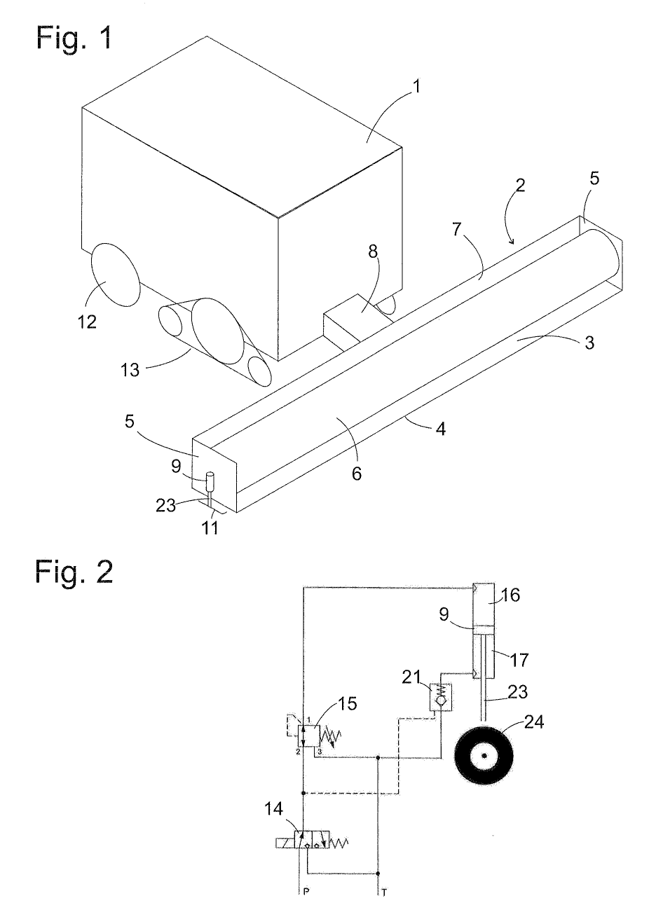

FIG. 2 is a schematic illustration of one half of a hydraulic system according to a first embodiment of the invention. Shown in the illustration is lifting cylinder 9, wherein the support assigned to lifting cylinder 9 is formed in this case by connecting rod 23 of the lifting cylinder and, instead of the skid, is formed by a wheel 24 which is rotatably held by connecting rod 23. In general, wheels or skids can be used in any of the embodiments described herein, and it is also feasible for an operator to be able to use either wheels or skids depending on the terrain and the crop.

Lifting cylinder 9 comprises a face-end side chamber 16 and a piston-ring side chamber 17. A pressure reducer 15 has a high-pressure port which is connected to a directional control valve 14, a controlled port connected to face-end side chamber 16, and a drain port which communicates via a port coupling T of front attachment 2 to a tank on board the vehicle. Directional control valve 14 has two inlets which can be connected selectively to the high-pressure port of pressure reducer 15, and one of which communicates via port coupling T with the tank, and the other of which communicates via a port coupling P with the high-pressure outlet of a pump on board vehicle 1. Piston-ring side chamber 17 is connected to port coupling T via a controllable non-return valve 21 which blocks the route from piston-ring side chamber 17 to port coupling T provided a high control pressure is not present at the high-pressure port of pressure reducer 15. A second half of the hydraulic system, which is structurally identical to that shown in FIG. 2, is assigned to second lifting cylinder 10.

If front attachment 2 is operating and is guided at a low height over a field to be harvested, directional control valve 14 is located in the position shown in FIG. 2. A high pressure delivered by the pump is present at the high-pressure port of pressure reducer 15 and at the control port of non-return valve 21. Chamber 17 is depressurized, and the secondary pressure set at pressure reducer 15 is present in chamber 16. If wheel 24 strikes a raised area on the ground and is forced upward, the pressure in chamber 16 rises above the secondary pressure of pressure reducer 15, and hydraulic fluid flows out of chamber 16 via pressure reducer 15—which functions in this case as a pressure relief valve—and the drain line thereof. In contrast, if a low area in the ground is driven over, hydraulic fluid flows from the pump via directional control valve 14 and pressure reducer 15 back into chamber 16, and connecting rod extends 23 until it once more supports a weight that corresponds to the product of the cross-sectional area of chamber 16 and the secondary pressure of pressure reducer 15.

If front attachment 2 is raised above the working height intended for the harvesting operation, e.g. in the turnaround, while directional control valve 14 is in the position shown in FIG. 2, connecting rod 23 extends until it reaches a stop in which the volume of piston-ring side chamber 17 is minimal. If, in this situation, front attachment 2 starts to roll and wheel 24 strikes the ground, connecting rod 23 is forced back against the pressure present in the face-end side chamber 16, and hydraulic fluid flows out of chamber 16 via a pressure relief valve integrated in pressure reducer 16, to tank port T. As a result, the rolling motion is braked continuously and without risk of damage to the front attachment.

Once the rolling motion has come to a standstill, the torsionally elastic design of feed rake 8 enables the front attachment to be rotated back into the equilibrium position thereof. The load on wheel 24 is relieved as a result, and hydraulic fluid can flow from the pump back to chamber 16. However, the throughput of directional control valve 14 and pressure reducer 15 is limited to such a low value that wheel 24 loses ground contact when the front attachment returns to the equilibrium position. The extension motion of wheel 24 is therefore unable to drive the rolling motion in the opposite direction and cause the other wheel to strike the ground.

When directional control valve 14 is switched to second position thereof, which is not shown in FIG. 2, the pressure at the high-pressure port of pressure reducer 15 diminishes, and non-return valve 21 blocks. If feed rake 8 is now lowered, and all of the weight of front attachment 2 rests on the two wheels 24, the pressure fluid flows out of chamber 16 via pressure reducer 15 to the tank, and connecting rod 23 is pressed into lifting cylinder 9. If front attachment 2 is now lifted once more, non-return valve 21 prevents connecting rod 23 from extending again due to the weight of wheel 24 mounted thereon, and therefore front attachment 2 can be lowered easily and safely onto a transport vehicle or a base.

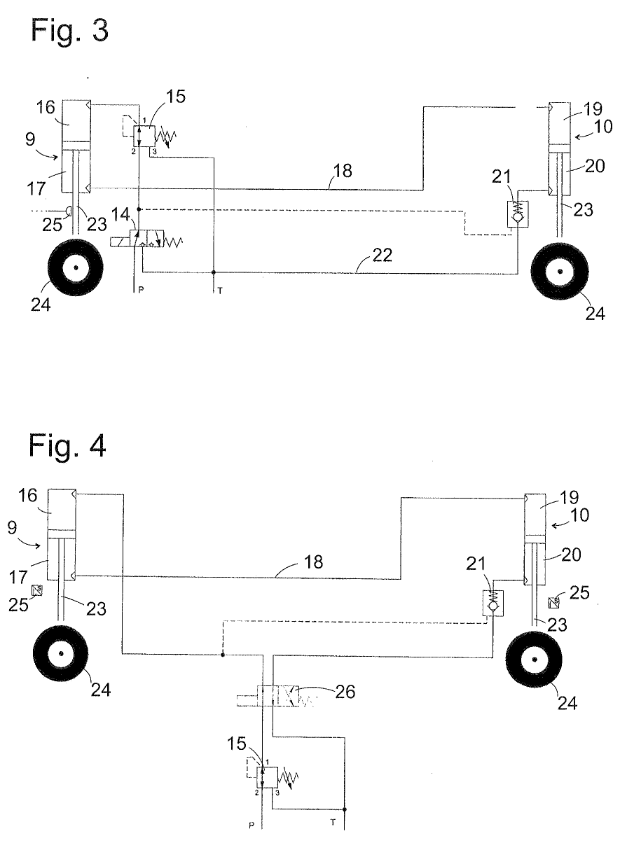

FIG. 3 shows a schematic illustration of a hydraulic system in which the two lifting cylinders 9, 10 are coupled to one another. Components of this hydraulic system that are similar to those of system shown in FIG. 2 are labelled with the same reference characters and are not explained again. In the configuration shown, directional control valve 14 is open, and the pump pressure is present at the high-pressure port of pressure reducer 15. The controlled outlet of the pressure reducer is connected to face-end side chamber 16 of lifting cylinder 9, and so it has the second pressure of pressure reducer 15. Piston-ring side chamber 17 of the same lifting cylinder 9 communicates via a compensating line 18 with a face-end side chamber 19 of lifting cylinder 10. A piston-ring side chamber 20 of lifting cylinder 10 is connected, in turn, via switchable non-return valve 21 to a low pressure line 22 leading to the tank of vehicle 1.

In the equilibrium state, the weight supported by the two lifting cylinders 9, 10 corresponds to the secondary pressure of pressure reducer 15, multiplied by the cross-sectional area of chamber 19. Chamber 20 is depressurized, and the pressure in chambers 17, 19 automatically sets in according to the distribution of the weight of front attachment 2 on the two rollers 24.

If right roller 24 travels over a raised area on the ground, the pressure in chambers 17, 19 increases, and if the pressure in chamber 16 then exceeds the set secondary pressure of pressure reducer 15, hydraulic fluid flows out of chamber 16 via pressure reducer 15 to low pressure line 22. At the same time, chamber 20 draws hydraulic fluid out of low pressure line 22. The two lifting cylinders 9, 10 therefore yield simultaneously. The diameter of lifting cylinder 9 is greater than that of lifting cylinder 10, and so the cross sections of chambers 17,19 can be made identical, and the lift of the two cylinders 9, 10 is identical. The yielding of lifting cylinder 10 under the pressure exerted by the passage over the raised area in the ground therefore does not cause torque to act on front attachment 2, which could trigger a rolling motion of front attachment 2; instead, the supporting force of lifting cylinders 9, 10 is merely redistributed onto feed rake 8. Since the latter supports front attachment 2 at the center of gravity, the supporting force additionally applied by same does not create torque. Instead, front attachment 2 drops only until the return force of the resilient suspension on feed rake 8 has compensated for the increased load.

In an analogous manner, lifting cylinder 9 is also pressed back upwardly if roller 24 thereof travels over a raised area on the ground. Simultaneously, hydraulic fluid is drawn out of chamber 19 of lifting cylinder 10 and into chamber 17 of lifting cylinder 9, and therefore lifting cylinder 10 yields.

If front attachment 2 is raised off of the ground when traveling in a turnaround, the mode of operation of the hydraulic system is substantially the same as that described above. Since only one of the two wheels 24 can have ground contact at any one time during a rolling motion, the total load-carrying capacity of the hydraulic system—which is the product of the secondary pressure of pressure reducer 15 and the cross section of chamber 16—is available for braking the rolling motion, regardless of which of the two rollers 24 touches the ground.

According to a development, a sensor 25 can be provided for detecting the vertical position of connecting rod 23 on lifting cylinder 9 or 10. The measurement signal of sensor 25 can be used to track the height of front attachment 2 over the ground using lifting cylinders of vehicle 1, which act on front attachment 2 or feed rake 8.

FIG. 4 shows an alternative embodiment of the hydraulic system. Lifting cylinders 9, 10 are structurally identical to those in the second embodiment and are not described again. In this case, pressure reducer 15 is connected directly to the pump via port P, and a directional control valve 26—in the position thereof shown in the figure—connects the controlled outlet of pressure reducer 15 to chamber 16 of lifting cylinder 9. Chambers 17, 19 are connected by a compensating line 18, as in FIG. 2, and chamber 20 is connected to tank port T via non-return valve 21 and directional control valve 26. When directional control valve 26 is in the position shown in FIG. 4, lifting cylinders 9, 10 behave just as they do in the embodiment shown in FIG. 3. In a second position of directional control valve 26, however, the controlled outlet of pressure reducer 15 is connected to chamber 20 of lifting cylinder 10, and chamber 16 of lifting cylinder 9 is connected to tank port T. In this position of directional control valve 26, hydraulic fluid flows from pressure reducer 15 into chamber 20, and out of chamber 19 into chamber 17. Connecting rods 23 can therefore be moved into the retracted stop position thereof, without the need to lower front attachment 2 on vehicle 1. The amount of time required to retract connecting rods 23 is as brief as for the embodiment depicted in FIG. 2 or 3.

The feature common to the embodiments in FIGS. 3 and 4 is that they can perform their function of suppressing rolling motions of front attachment 2 provided only that high pressure is present at pump port P in order to maintain the secondary pressure at pressure reducer 15. If connecting rods 23 have yielded when a raised area on the ground is traveled over, then pressurized hydraulic fluid must be supplied in order to restore the previous state. Drive power must be provided for this purpose, which increases the fuel consumption of the working machine.

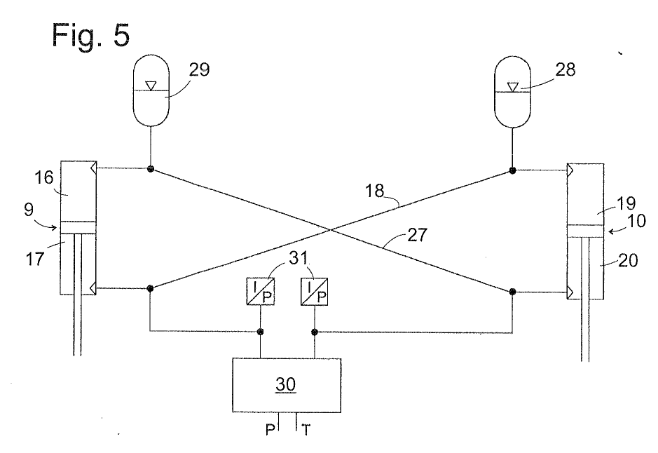

By comparison, FIG. 5 shows a diagram of a hydraulic system according to a fourth embodiment of the invention, which functions even when hydraulic fluid under high pressure is not continuously available. Lifting cylinders 9, 10 of this embodiment differ from those shown in FIGS. 3 and 4 in that the former have identical cross sections. Not only is compensating line 18 provided between piston-ring side chamber 17 of lifting cylinder 9 and face-end side chamber 19 of lifting cylinder 10, but, conversely, compensating line 27 is also provided between piston-ring side chamber 20 and face-end side chamber 16. One pressure buffer 28 and 29 is connected to each of the two compensating lines 18, 27. When the hydraulic system is in equilibrium, the pressures in all four chambers 16, 17, 19, 20 are identical, and the supporting force used to support skids 11 or wheels 24 at the lower end of connecting rods 23 on the ground during the harvesting operation is the product of said pressure with the cross section of connecting rods 23. Due to the coupling via compensating line 18, 27, the two connecting rods 23 yield in the same manner if force acts on one of them that is greater than the above-mentioned supporting force. Due to the uniform retraction motion of the two lifting cylinders 9, 10, the ground drive of vehicle 1 is loaded additionally via feed rake 8 and applies the remaining force required to support front attachment 2 without exerting torque onto front attachment 2.

A valve block 30 connects a pump port P and a tank port T selectively to the two compensating lines 18, 27. When the hydraulic system is operating, valve block 30 is completely blocked, and pressure fluid is merely exchanged between chambers 16, 20 or 17, 19 and particular pressure buffer 28 assigned thereto. If one of the two connecting rods 23 is forced backward during operation, face-end side chambers 16, 19 of the two lifting cylinders 9, 10 become smaller, and the displaced hydraulic fluid is distributed between piston-ring side chambers 20, 17 of the particular other lifting cylinder and pressure buffers 28, 29. As soon as the force acting on the connecting rod diminishes, the two lifting cylinders return to their neutral position, driven by the pressure in buffers 28, 29.

The extent to which connecting rods 23 are extended in said neutral position depends on the pressure in chambers 16, 17 or 19, 20, or on the quantity of hydraulic fluid in the two branches of the system composed of chambers 16, 19, compensating line 18, and pressure buffer 28 connected thereto, and chambers 16, 20, compensating line 27, and pressure buffer 29 connected thereto. The greater the quantity of hydraulic fluid is in the system, the further the connecting rods 23 are extended for a given supporting force. The quantity of hydraulic fluid in the two branches of the system must be equal for the two connecting rods 23 to be extended by equal distances in an equilibrium position. To adapt this quantity as necessary, a connection is established in valve block 30 between pump port P or tank port T and one of the compensating lines 18, 27. Sensors 31 are provided to ensure that the two branches contain the same amount of hydraulic fluid. They deliver measured flow rate values which can be integrated to monitor the quantity of hydraulic fluid in each branch. The sensors also deliver measured pressure values which make it possible to determine the volume of the connected branches and, therefore, the position of connecting rods 23. Instead of flow rate/pressure sensors 31, position sensors 25 could also be provided, as shown in FIG. 3, although in this case one sensor 31 or 25 is required for each lifting cylinder 9 or 10, because the quantity of hydraulic fluid in the branch comprising chambers 17, 19 can change, in contrast to the embodiment depicted in FIG. 3.

When front attachment 2 is lifted off of the ground while chambers 16, 17, 19, 20 are pressurized, connecting rods 23 extend to a stop—as described with reference to the first embodiment—at which the volume of piston-ring side chambers 17, 20 is minimal, and therefore all of the freedom of motion of connecting rods 23 is available as a braking path to absorb a rolling motion

1. An agricultural working machine, comprising a vehicle; a front attachment guided such that it is swivelable about an axis in a direction of travel during a harvesting operation; a frame on which working tools are mounted; and means provided on a unit selected from the group consisting of a chassis of said vehicle or said front attachment for applying a force that counteracts a swivel motion of said vehicle or said front attachment induced by a parameter selected from the group consisting of driving speeds, uneven terrain, and both.

2. An agricultural machine as defined in claim 1, wherein said means for applying a force to said front attachment to counteract a swivel motion of said front attachment includes at least two interspaced supports disposed on said frame in a vertically movable manner for supporting, in contrast with a ground, at least a portion of a weight of said front attachment, wherein said supports are yieldable reversibly to apply a supporting force to counteract said swivel motion of said front attachment when at least one of said supports contacts the ground.

3. An agricultural machine as defined in claim 2, further comprising a connection between said vehicle and said front attachment configured as an elastic connection relative to a rolling motion of said front attachment, thereby ensuring that after said front attachment is swiveled out of a neutral position, a return motion of said front attachment in a direction of said neutral position is driven, wherein said supports which yielded in response to said swivel motion lose contact with the ground.

4. An agricultural machine as defined in claim 2, wherein said supports are configured so that a maximum load-carrying capacity of said supports, which when exceeded causes said supports to yield, is less than a weight of said front attachment.

5. An agricultural machine as defined in claim 2, wherein said supports include at least one first lifting cylinder, further comprising a pressure relief valve which limits a pressure in at least one of chambers of first lifting cylinder.

6. An agricultural machine as defined in claim 2, wherein said supports include at least one first lifting cylinder having a chamber connected to a first buffer, such that if a maximum load-carrying capacity is exceeded, hydraulic fluid is displaceable out of said chamber and into said first buffer.

7. An agricultural machine as defined in claim 2, further comprising a coupling device provided between said two supports so that when one of said supports yields under load, another of said supports moves in a same direction as said one support.

8. An agricultural machine as defined in claim 2, wherein said supports include a first lifting cylinder and a second lifting cylinder which are double acting, each of said lifting cylinders having a first chamber which is actable upon with hydraulic fluid to exert a downwardly directed force onto one of said supports assigned to a particular one of said lifting cylinders, and a second chamber which is actable upon with hydraulic fluid to apply an upwardly directed force onto said support, wherein said first chamber of said second lifting cylinder communicates with said second chamber of said first lifting cylinder.

9. An agricultural machine as defined in claim 8, wherein said first chambers are face-end side chambers, while said second chambers are piston-ring side chambers.

10. An agricultural machine as defined in claim 8, wherein said first chamber of said first lifting cylinder communicates with a pressure relief valve, while said first lifting cylinder has a larger cross-section than said second lifting cylinder.

11. An agricultural machine as defined in claim 8, further comprising a releasable non-return valve provided between said second chamber of said second lifting cylinder and a tank.

12. An agricultural machine as defined in claim 8, wherein said second chamber of said second lifting cylinder communicates with a first buffer and said first chamber of said second lifting cylinder and said second chamber of said second lifting cylinder communicate with said buffer.

13. An agricultural machine as defined in claim 12, wherein said second chambers have a smaller cross-section than said first chambers.

14. An agricultural machine as defined in claim 1, wherein said supports have a ground-touching tip which is formed as an element second from the group consisting of a skid and a roller.

15. An agricultural machine as defined in claim 2, further comprising means for detecting a vertical position of each of said supports.

16. An agricultural machine as defined in claim 1, further comprising a crawler track assembly.
